(19) United States
(12) Patent Application Publication
(10) Pub. No.: US 2010/0274755 A1
(43) Pub. Date: Oct. 28, 2010

(54) BINARY SOFTWARE BINARY IMAGE ANALYSIS

(76) Inventor: Richard Alan STEWART, San Diego, CA (US)

Correspondence Address: QUALCOMM INCORPORATED, 5775 MOREHOUSE DR., SAN DIEGO, CA, 92121, US

(21) Appl. No.: 12/431,036

(22) Filed: Apr. 28, 2009

(51) Int. Cl. G06F 17/00

(52) U.S. Cl. 706/54

(57) ABSTRACT

Methods and computing devices enable identifying particular software functions, modules or arithmetic blocks within a software binary image. Memory register and memory address references within the binary image are normalized. Functions within the binary image are identified. Each function within the binary image is compared against one or more reference function binary images to determine if there is a match. The function-to-reference function comparison may be accomplished by comparing bit patterns or by comparing hash values generated by applying a hash function to the selected function and the reference function. Component parts within functions in the binary image can be identified and compared to reference function component parts within a reference function or within a database of reference function component parts. Results of the comparisons may be used to determine a degree to which the software binary image matches reference functions and/or component parts.

### FIELD OF THE INVENTION

The present invention relates generally to computer systems, and more particularly to methods and apparatus for analyzing executable software to recognize particular functions, algorithms or modules.

### BACKGROUND

Computers and mobile devices are configured with software which instructs their processors with a sequence of instructions. Software is typically written in source code, which is a human-readable computer programming language. In order for a processor to understand and execute a sequence of instructions the source code must be compiled into executable binary code, which is a sequence of 1's and 0's that encode the instructions in processor-executable format. The process of compiling source code into a finished executable format is sometimes referred to as a “build” and the assembled executable software is sometimes referred to as a binary image.

As computer and mobile device applications expand in complexity, there is software developers have a growing need for tools to enable them to determine what source code has been compiled into an executable binary image. Such tools can be used for internal analysis such as insuring that a bug fix is included in a build, or insuring that no general public license (GPL) code is included in a build. Traditional methods for ensuring that a released software image is free of errors rely on keeping track of or analyzing the source code used to generate a given executable binary image. However, such traditional methods are unable to directly analyze the executable binary image, and thus may not accurately reflect what is in the binary image and are of little value for analyzing executable software for which the source code is unavailable.

### SUMMARY

Various embodiment methods and systems analyze an executable software binary software binary image in order to recognize particular functions, portions of functions, algorithms and arithmetic blocks. Memory register and memory address references within the software binary image are normalized. Functions within the binary image are identified. Each identified function within the binary image is compared against one or more reference binary images of known or reference functions to determine if there is a match. The reference function binary images may be stored in a reference database containing a plurality of function binary images. The function-to-reference function comparison may be accomplished by comparing bit patterns or by comparing hash values generated by applying a hash function to the function and the reference function. In an embodiment, component parts within functions within the binary image under analysis are identified and compared to binary images of function component parts within a reference function or within a database of reference function component part binary images. The component part-to-reference component part comparisons may be accomplished by comparing bit patterns in the respective binary code or by comparing hash values generated by applying a hash function to each of the component part and the reference component part. Results of the comparisons may be used to determine a degree to which the software binary image matches one or more reference functions and/or component parts of functions.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain features of the invention.

FIG. 1 is a process flow diagram of a first embodiment method for analyzing a software binary image.

FIG. 2 is a process flow diagram of an alternative embodiment method for analyzing a software binary image.

FIG. 3 is a process flow diagram of a detail portion of the embodiment method illustrated in FIG. 1.

FIG. 4 is a process flow diagram of another detail portion of the embodiment method illustrated in FIG. 1.

FIG. 5 is a process flow diagram of an alternative detail portion illustrated in FIG. 4.

FIG. 6 is a process flow diagram of an alternative embodiment method for analyzing a software binary image.

FIG. 7 is a process flow diagram of an alternative embodiment method for analyzing a software binary image.

FIG. 8 is a process flow diagram of an alternative embodiment method for analyzing a software binary image.

FIG. 9 is process flow diagram of a method for generating a reference function binary image database according to an embodiment.

FIG. 10 is a process flow diagram of a method for generating a reference function and arithmetic block binary image hash database according to an embodiment.

FIG. 11 is a component diagram of a computer system suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

In this description, the terms “exemplary” is used herein to mean “serving as an example, instance, or illustration.” Any implementation described herein as “exemplary” is not necessarily to be construed as preferred or advantageous over other implementations.

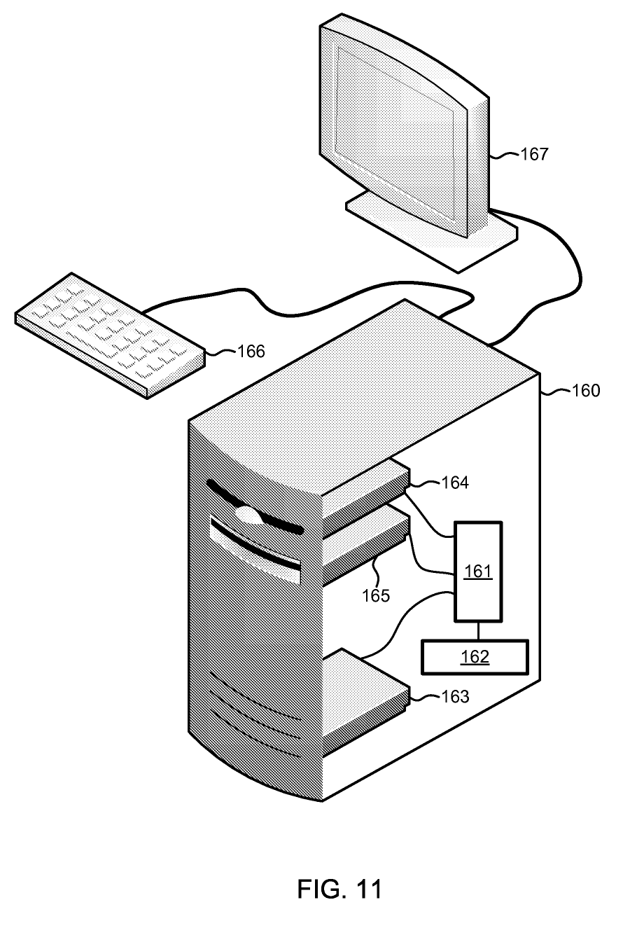

As used herein, the terms “computer” and “computer system” are intended to encompass any form of programmable computer as may exist or will be developed in the future, including, for example, personal computers, laptop computers, mobile computing devices (e.g., cellular telephones, personal data assistants (PDA), palm top computers, wireless data cards and multifunction mobile devices), main frame computers, servers, and integrated computing systems. A computer typically includes a software programmable processor coupled to a memory circuit, but may further include the components described below with reference to FIG. 11.

As used herein, the terms “software binary image,” “binary image,” “binary code” and “code” refer to executable (i.e., compiled) software in binary form, i.e., as a sequence of “1's” and “0's”. As used herein, the terms “code block,” “block of code” and “block” refer to a particular subset of a binary image, such as a number of bits or bytes in sequence. As used herein, the term “function” refers to a sequence of software instructions which, when executed by a processor, accomplish some desired result. Some functions may include one or more other functions. As used herein, the term “component part” refers to a portion of a function that is less than the entire function. As used herein, the term “module” refers to a portion of an application program that is separately developed and tested, and is typically combined (either before or after compiling) with other modules in the build that generates the executable binary image for an application.

As used herein, the terms “hash algorithm” are intended to encompass any form of computational algorithm that given an arbitrary amount of data, computes a fixed size number which can be used (with some probabilistic confidence) to identify an exact version of the input data. The hash algorithm need not be cryptographically secure (i.e. difficult to determine an alternate input that computes to the same reduced number), however the context in which it is used may mandate such a requirement. As used herein, the terms “hash” and “hash value” are intended to refer to the output of a hash algorithm.

There is a growing need to understand what source code has been compiled into an executable binary image. This need can be driven by internal analysis, such as insuring a build includes a particular bug fix or does not contain any general public license (GPL) code. A frequent problem encountered in developing complex computer software is determining whether a particular software build includes a portion of executable code that includes a known bug or problem. In complex software builds, particularly software involving many different development groups and implementers, software bugs can be introduced inadvertently even though each individual software component module has been thoroughly tested. Current methods of testing component software modules and tracking source code lineage are vulnerable to human process errors in assembling the final image, and thus are not perfect methods for ensuring an executable binary image release is flawless. Often the bugs which are introduced into complex software applications are known, but reside in small algorithms, modules or functions that are inadvertently copied in at some point in the overall assembly and build process by individuals unaware of the problem. A defective algorithm, module or function may be nearly indistinguishable from correct code, and thus not readily recognizable using simple comparative techniques. Further, the bug may reside in code that is introduced after most modules are compiled, and thus not identifiable by analyzing the source code. Variations in memory usage, register assignments and variable names change the binary image of compiled code making it impossible to spot problematic code using direct binary comparison techniques.

To solve this problem and overcome the deficiencies of traditional methods of surveying source code and tracking source code lineage, the various embodiments provide methods for analyzing the software binary image directly. These methods can recognize particular reference functions, components of functions, algorithms and arithmetic blocks which are included within a binary image under analysis. Using such methods a software binary image can be quickly scanned to determine if any known problematic code elements are included without relying upon an analysis of the source code. Additionally, the methods enable any software binary image to be scanned to determine whether there is a likelihood that any known software routines or modules have been included. For example, the methods can be used to determine whether any company software has been copied into software that is only available as an executable binary image.

Two basic embodiment methods are described herein for identifying the source code lineage within a given software binary image. A first embodiment method is applied to identify exact code matches. That is, if a known function is included in a software binary image, a match will be detected. A second embodiment method is applied to detect likely code matches. That is, if a function contains portions of a known implementation, the percentage of the known implementation can be detected and reported.

In the exact match embodiment method each software function is identified within the binary image under analysis. The beginning and end instructions of identified functions may be recorded or tagged in the binary image, or the block of binary code containing each function may be copied into a temporary database. Each identified function has its register assignments and memory allocations adjusted (“normalized”) to be consistent with how memory addresses and registers are assigned in the database of reference function binary images. The binary code of each identified and normalized function is then compared to one or more binary images of reference functions to determine if any match. This comparison may be accomplished using bit pattern recognition techniques on a bit-by-bit or byte-by-byte basis. Alternatively as an optimization, a hash algorithm may be applied to the binary code corresponding to each function under analysis to generate a hash value which can be arithmetically compared to hash values generated for each of the reference function binary images in the database. When a match between hash values is found a match can be identified and recorded. In this manner, each function in the binary image can be individually compared each of a plurality of reference function binary images stored in a database in order to scan the binary image for matches to a library of reference functions.

The likely match embodiment method is similar to the exact match embodiment method except that the comparison can be accomplished at the level of function component parts. The binary image of each reference function in the reference database can be broken down into its component parts with the component part binary images stored in a reference database of functions and function component part binary images. Optionally, a hash can be generated for each of the function binary images and function component part binary images in the reference database with the resultant hash values stored in a reference hash database. The software binary image under analysis is preprocessed to normalize registers and memory address references and then broken down into functions and component parts of functions which may be record, tagged or stored in a temporary database. Each of the component parts may then be compared to function component parts stored in a reference database of compiled function component parts in the a bit-by-bit or byte-by-byte manner. Optionally, a hash function may be applied to each component part binary image to generate a hash value. Each component part hash value can be compared to the reference hash database and matches are identified. A table or similar listing of each matched function and component part matched to the database can be generated. The likelihood that a function within the binary image under analysis is the same or nearly the same as a reference function within the reference database can be inferred based on the percentage of component parts in the software binary image that match component parts of reference functions reflected in the reference hash database. Any given function within the binary image under analysis may have matches for component parts from one or more reference functions. If a significant percentage of component parts within a function within the binary image are matched to component part binary images in the reference database this may indicate it is likely that a function or portions of a function have been copied. A likely match can then be confirmed by conducting a more in-depth analysis of the matching portions of the binary image under analysis to the matched reference function binary image within the reference function database. Such a more in-depth subsequent analysis may include a bit for bit analysis of binary images or a line by line review of corresponding source code.

One method used to confirm whether a particular large block of binary code is the same as another is to apply a hash algorithm, such as a cyclic redundancy check (CRC) algorithm or the MD5 cryptographic hash algorithm, to each binary code block to generate a number (i.e., a hash value), and then compare the two hash values. Such methods can be used to authenticate a particular software binary image by comparing its hash value to a hash value provided by an authenticating agency. When the authenticating agency tests and confirms that a particular software binary image is free of errors or malware, the agency can generate a cryptographic hash of that software binary image using a private encryption key. In some implementations the authenticating agency may use a private encryption key that allows recipients to decode the digital signature to also confirm that the authenticating agency generated the cryptographic hash. The hash value is then included with the released software package so that computers can confirm the software binary image version by performing a similar cryptographic hash algorithm on the software binary image and comparing the result to the hash value associated with the software. Such methods are well known in the computer arts. However, this traditional hash comparison method only determines whether two binary images are identical. Even a small difference between the two binary images buried deep within one of the images will result in a different generated hash value. Thus, the traditional hash comparison methods of verifying software binary images cannot determine any information regarding included functions and component parts of functions.

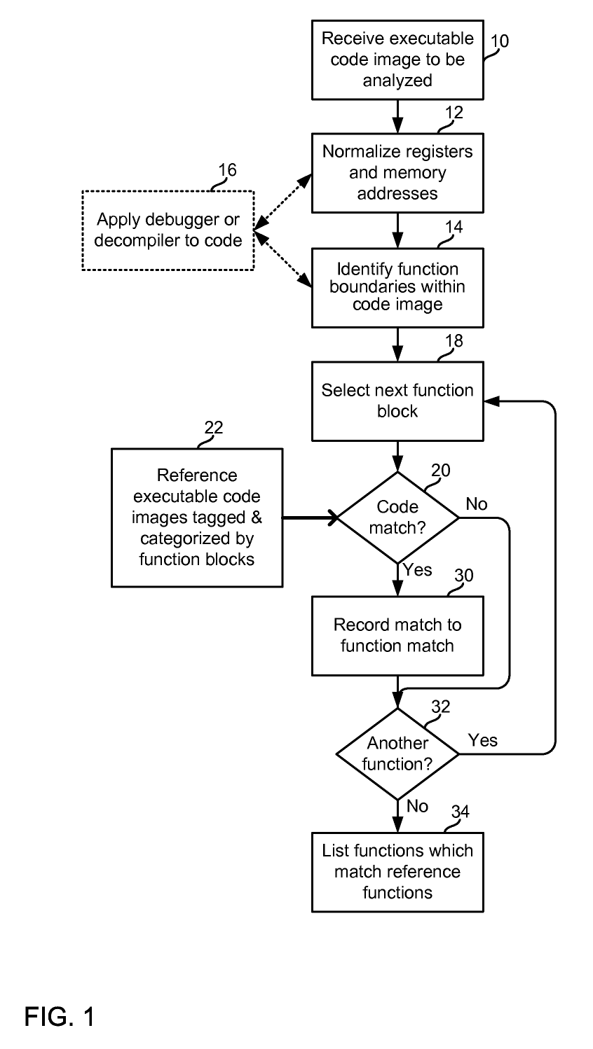

FIG. 1 is a process flow diagram illustrating example steps which may be implemented in the exact match embodiment method. As mentioned above, this embodiment method seeks to identify exact function matches within a software binary image under analysis to one or more known reference functions which may be stored in a reference database of function binary images. An executable software binary image may be received by a computer configured with software to execute the embodiment method, step 10. A software binary image may be received in a variety of forms, including for example, on a tangible storage medium such as a compact disc (CD), digital video/versatile disc (DVD), from an internal or external memory such as a disc drive or USB memory unit, or from a network via a network connection. Once received, the software binary image may be preprocessed to prepare it for analysis. This preprocessing includes normalizing register and memory address references within the binary image to generate a normalized binary image, step 12, and identifying function boundaries within the binary image, step 14. While FIG. 1 shows the step of normalizing registers and memory addresses, step 12, preceding the step of identifying function boundaries within the binary image, step 14, that order is for illustrative purposes only because these steps may also be performed in the reverse order (i.e., step 14 before step 12) or the same preprocessing step.

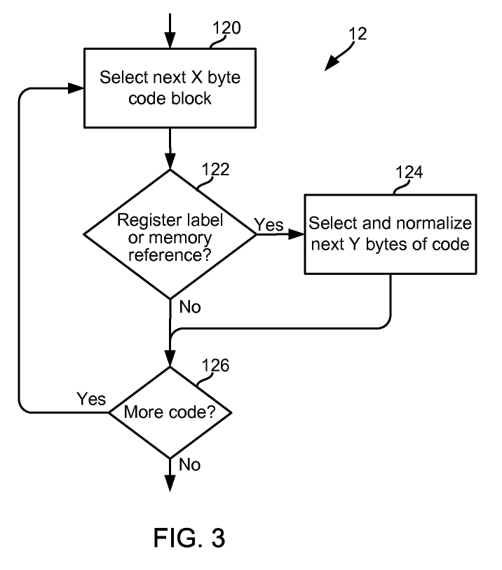

In the process step of normalizing registers and memory addresses, step 12, the software binary image under analysis is scanned to identify references to memory registers and memory addresses, and the identified registers and addresses are changed to a normalized value, such as all zeros. The normalized value is the same value assigned to memory registers and addresses for reference functions stored in the reference function database 22 which is described further below. This normalization of registers and memory addresses is done to ensure that the analysis of the software binary image can recognize functions and instruction patterns without being misled by register and memory address assignments. Typically, register and memory address assignments for different blocks of compiled software will depend upon memory assignments that are included in other parts of the software surrounding a particular function. This variability in register and memory address assignments contributes to the problem of identifying functional blocks within a software binary image, since two identical functions implemented in different software builds may be assigned different registers and memory addresses, making the two software binary images appear different. Normalizing the registers and memory addresses within the software binary image to generate a normalized binary image enables the subsequent analysis to focus on instruction sequences since all registers and addresses will then be the same within the binary image under analysis and the reference function binary images stored in the reference database 22. Memory register and address assignments can be identified in the binary image under analysis using a variety of methods, including analyzing the binary image using a decompiler or well known techniques for identifying the beginning and end of a function for a given compiler on a given processor, step 16, or scanning the binary image to recognize register or memory address references within the binary sequence as described below with reference to FIG. 3.

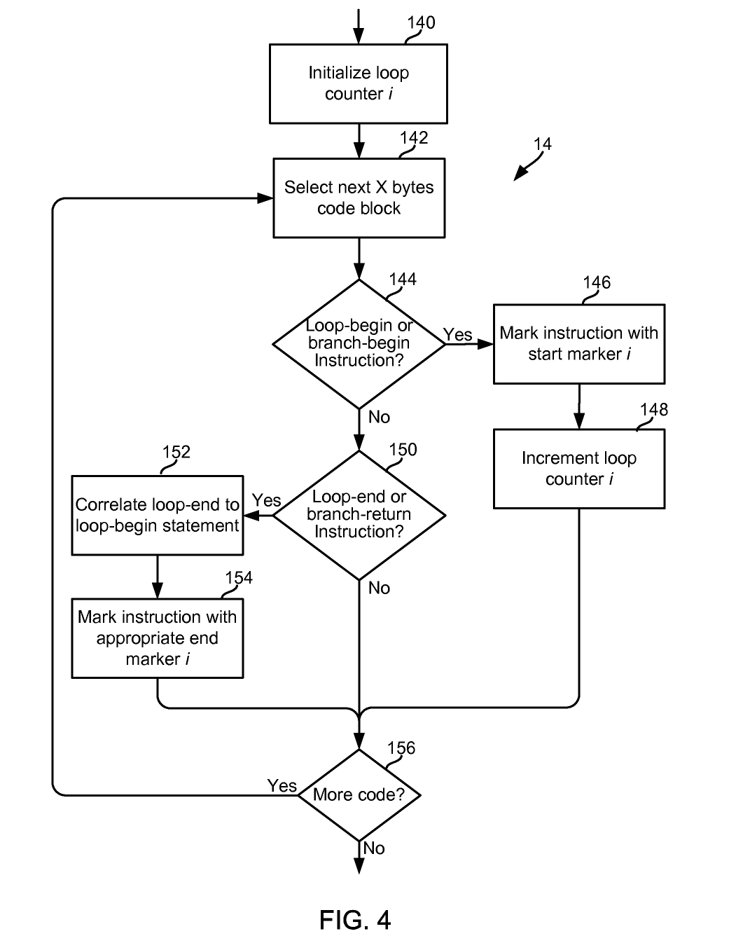

In order to analyze the software binary image at the function level, the software binary image is also analyzed to identify function boundaries within the binary sequence, step 14. This process essentially breaks the software binary image up into functional blocks of binary code which can be individually analyzed and compared to known functions stored in the reference database 22. Analyzing the software binary image at the functional level enables the embodiment method to recognize particular functions within the compiled software without having to consider the source code that was compiled to create the binary image. Function boundaries can be identified within the binary sequence of the software binary image using known methods such as a decompiler application or well known techniques for identifying the beginning and end of a function for a given compiler on a given processor, step 16, which parses through the binary sequence recognizing instructions and identifying functional blocks. Alternatively, the embodiment method can scan through the binary sequence of the binary image to identify instruction patterns associated with the beginning and end of functions, and use those recognized instruction patterns to set out the functional boundaries as described more fully below with reference to FIG. 4.

When functional boundaries are identified within the binary image under analysis, the location of the beginning and ending bits of the blocks of binary code associated with each function may be stored in memory, such as in the form of pointers, or identified with boundary labels (e.g., flags or unique bit patterns) added to the binary image. Alternatively, each function's block of binary code may be separately stored in a temporary database of functions. Storing the beginning and ending bit locations in memory or tagging the binary image with functional boundary labels enables the subsequent processing to work through the binary sequence of the software binary image from start to finish, analyzing each function in the sequence in which it appears in the binary image. Separately storing the blocks of binary code of identified functions in a temporary database permits each function to be analyzed in an arbitrary sequence without further parsing of the binary image under analysis. The blocks of binary code for each identified function may also be stored in a temporary database in the order in which they appear in the binary image under analysis, enabling the functions to be analyzed in the sequence in which they appear.

With the registers and memory addresses normalized and function boundaries identified (or functions individually stored within a temporary database), the process of individually analyzing each function can begin. This processing can be performed in a loop that works its way through the software binary image as shown in FIG. 1. To do so, a function block of code is selected for analysis, step 18. In the first pass through the analysis loop the function block of code selected in step 18 will be the first function block of code in the binary sequence or within the temporary database, while in subsequent passes through the analysis loop the next function block of code selected in step 18 will be the binary sequence or database. In this selection, the entire block of code associated with the selected function may be stored in active memory so that the pattern of bits within that block of code can be compared in test 20 to reference binary images of reference functions. The reference binary images may be stored in a reference database 22 so that each selected function can be compared to one, some or all reference functions within the database. This comparison test 20 can be accomplished using well-known methods for comparing bit sequences, including pattern recognition and bit-by-bit or byte-by byte comparisons. A single reference function binary image may be compared to the selected function block of code in test 20, as may be the case when the analysis is being conducted to determine if a particular function has been included in the binary image under analysis. Alternatively, a plurality of reference binary images within a database of reference function binary images 22 may be compared to the selected function block of code to determine if any of the functions included in the database are present in the selected function block of code under analysis.

In an embodiment, the selected function block of code may be compared to reference function binary images in the reference database 22 at a subunit level (i.e., portions of the selected block of code) instead of comparing the entire selected block of code as a whole to a reference function binary image. For example, the analysis may be performed over a number of bytes within the selected block of code, such as four to ten bytes at a time, in order to simplify the comparison process. As another example, the analysis may be performed at the level of arithmetic units, such as by selecting blocks of code between conditional statements (i.e., instructions which will result in branching depending upon a conditional test, such as the compiled implementation of an “if—then” software step). Such block-by-block or segment-by-segment analysis may be easier to perform than a whole-function comparison, and may be used to recognize functions that have been implemented in a manner that is slightly different from binary image of the reference function stored in the reference database 22. The results from block-by-block or segment-by-segment comparisons can then be combined to determine whether the overall function selected in step 18 matches a function in the reference database 22 in test 20. In other words, if all blocks or segments match corresponding blocks or segments within a function in the reference database 22 in the same order that they appear in the reference function, then the selected function matches that particular reference function. If all blocks or segments match corresponding blocks or segments within a function in the reference database 22 but not necessarily in the same order that they appear in the reference function, this indicates that there is a likelihood that the functions match. Similarly, if many of the blocks or segments match corresponding blocks or segments within a function in the reference database 22, this also indicates that there is a likelihood that the functions are functionally equivalent. As discussed more fully below, if the comparison reveals that there is a likely match, further analyses may be conducted to determine if the selected function and the reference function match exactly or if the reference function has been copied.

In a further embodiment, pattern matching may be combined with analysis techniques used in text analyzers to recognize matching blocks or segments within a function when not all blocks or segments match up with blocks or segments of a reference function within the reference database 22. In some cases, the implementation of a function may result in some code being interspersed between common component parts within the function such that the selected function block of code may not exactly match a reference function within the reference database 22 even though the functions are functionally equivalent in operation. For example, a reference function within the reference database 22 may be slightly modified in the binary image under analysis with the addition of some code somewhere in the middle of the selected function which does not change its overall process. As an example, a function may be implemented with a particular component part being replaced by an equivalent but slightly different component part. As another example, some inconsequential code may be added to the function so as to make the overall function block of code appear different.

When such a selected function is compared on a block-by-block or segment-by-segment basis to reference functions, blocks or segments may be found to match those of a reference function in the reference database 22 until the inserted or varied portion is encountered, at which point no match will be found. Subsequent blocks or segments within the selected function then will not match since the substituted or inserted binary code will offset the rest of the binary code in the selected function block of code from the bit sequence in the reference function binary image in the reference database 22. To overcome this problem, pattern recognition software, such as used in text analyzer applications, may be implemented to scan the bit sequence in the selected function block of code following a non-matching block or segment to determine if the selected function block of code can be resequenced with a reference function binary image in the reference database 22. In this process, subsequent bit patterns are analyzed to determine if there are any matching patterns between the selected function block of code and the reference function binary image. If a subsequent bit pattern match is recognized within the selected function block of code, this information can be used to restart the block-by-block or segment-by-segment comparisons to the reference function binary image at the point where the bit patterns match up. Using this method, function matches can be identified even when the component parts are implemented in a different order or the block of code under analysis has been modified to conceal the fact that it has been copied.

If the code matching analysis conducted in test 20 determines that the selected function block of code matches or closely matches a reference function binary image within the reference database 22, the particular match to a reference function may be recorded, step 30. Unless only a single function is being searched for (in which case a match may cause the process to terminate), the process can continue by determining whether there is another function within the binary image to be analyzed, test 32, and if so, returning to the process step of selecting the next function block of code for analysis, step 18. If the code matching analysis conducted in test 20 determines that the selected function block does not match or closely match a reference function binary image within the reference database 22 (i.e., test 20=“No”), the process may continue to select the next function block of code for analysis by determining whether there is another function to be analyzed, test 32, and if so, returning to the process step of selecting the next function block of code for analysis, step 18. Once all functions within the binary image under analysis have been analyzed (i.e., test 32=“No”), the analysis process may terminate by listing all of the functions which were found to match the reference functions included within the reference database 22, step 34.

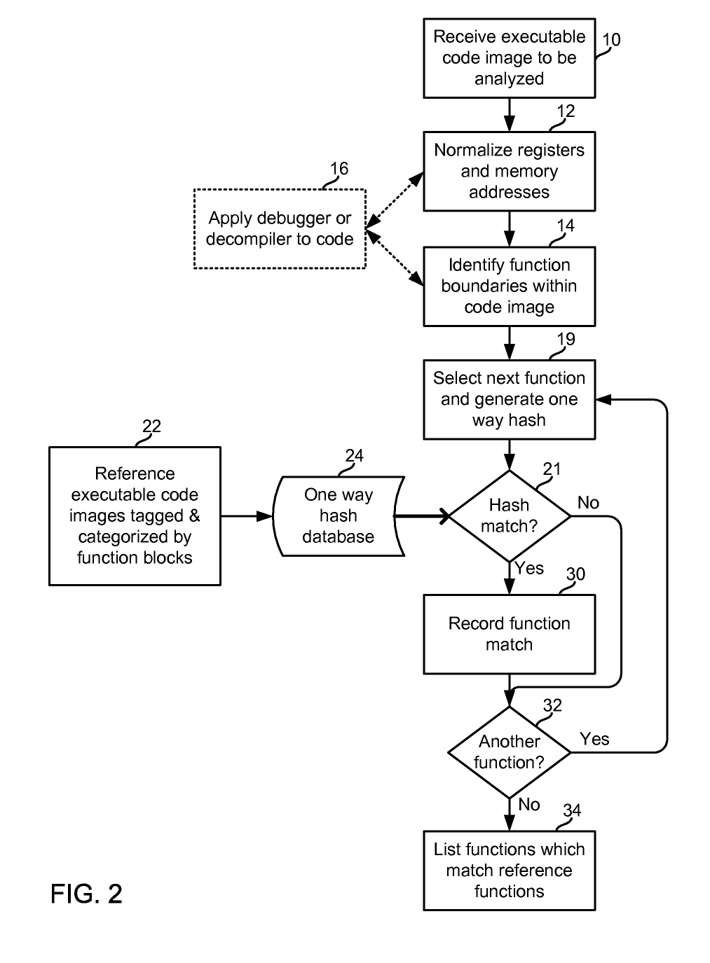

An alternative embodiment for analyzing a software binary image for exact or near exact matches to reference function binary images within a reference database is illustrated in FIG. 2. In this alternative embodiment, the processor-intensive steps of bit-by-bit, block-by-block or segment-by-segment comparisons of selected portions of binary code to a library of function binary images are replaced by a more efficient comparison of code segment hash values. As described above, a hash algorithm can be used to convert a large binary sequence (e.g., a portion of compiled software code) into a much smaller number that is statistically unique to that particular binary image. The chance that two different binary images will result in the same hash value depends upon the size of the binary image and the number of digits in the hash value, but for typical hash algorithms this probability is so low that the hash values may be treated as uniquely identifying their associated binary images. Comparing two hash values is a simple arithmetic operation since the two numbers can simply be subtracted to determine if there is a remainder—if there is a remainder, then the two binary images are different. As a result of this simplified processing, functions and function component parts can be quickly compared to a large number of reference function binary images. However, subtle differences between the selected function block and a reference function image will result in a determination that there is no match even though a block-by-block or segment-by-segment comparison as described above with reference to FIG. 1 might detect a match. Thus, the embodiment illustrated in FIG. 2 is able to analyze binary images against a large database much faster, but with the disadvantage that close matches may be overlooked.

The process steps involved in the embodiment illustrated in FIG. 2 involve many of the steps described above with reference to FIG. 1. In particular the software binary image received in step 10 is preprocessed to normalize registers and memory references, step 12, and to identify function boundaries, step 14. As with the embodiment illustrated in FIG. 1, the analysis of the software binary image may proceed in a loop to analyze each identified function in turn. To analyze each function, a function is selected and a hash value generated for that selected block of code, step 19. As with step 18 described above with reference to FIG. 1, in the first pass through the analysis loop the function block of code selected in step 19 will be the first within the binary sequence or within the temporary database, while in subsequent passes through the analysis loop the next function block of code selected in step 19 will be the binary sequence or database. The generated hash value for the selected function block of code may then be compared in test 21 to a hash value of a particular reference function binary image or to hash values within a hash database 24. The hash algorithm used to generate the hash value for the selected function in step 19 is the same hash algorithm that is used to generate the hash values for reference function binary images. In an embodiment, the hash algorithm is a one-way hash, such as a CRC algorithm.

While the hash value for any reference function binary image may be generated at the time of the comparison in test 21, a more efficient approach involves generating the hash values for reference function binary images stored in the reference database 22 and storing those hash values in a hash database 24. Such a hash database 24 may include an identifier (ID) identifying the reference function associated with each hash value. The hash database 24 can then be generated at any time prior to beginning the analysis of a software binary image.

By using well-known binary number comparison techniques (e.g., subtract and test for remainder), the comparison accomplished in test 21 can quickly determine whether the hash value generated for the selected function block of code matches any of the hash values stored in the hash database 24. If any matches are detected (i.e., test 21=“Yes”), the identifier for the matching hash value in the hash database 24 may be recorded in step 30. Once the function match is recorded, step 30, or if no hash match is detected (i.e., test 21=“No”), the process may continue by determining whether there is another function in the binary image to be analyzed, test 32, and if so, returning to selecting the next function block of code for analysis and generating its hash value, step 19. Once all functions within the binary image under analysis have been analyzed (i.e., test 32=“No”), the analysis process may terminate by listing all of the functions which were found to match reference functions included within the reference database 22, step 34.

As mentioned above, memory register and memory address values can be identified and normalized, step 12, by using a decompiler application or well known techniques for identifying the beginning and end of a function for a given compiler on a given processor, step 16, or by directly scanning the binary image under analysis to recognize register or memory address references. An example of process steps that may be implemented within step 12 to scan the binary image under analysis for registers and memory address references is illustrated in FIG. 3. In this process, a block of binary code within the binary image may be selected, step 120, with the selected block sized in terms of bytes to correspond to the size of instructions associated with register and memory address references. The selected block of binary code is then compared to the binary bit patterns for known register or memory location references, test 122. As shown in FIG. 3, this process may be structured as a loop to work through the binary image under analysis. In the first pass through the loop the code block selected in step 120 will be the first X bytes within the binary image, while in subsequent passes through the analysis loop the code block selected in step 120 will be the next X bytes of code in the binary image beyond those processed in the previous pass (i.e., either X or X+Y bytes beyond the last selection). If the selected block of code includes a register or memory location reference (i.e. test 122=“Yes”), a subsequent block of bits is selected and normalized (e.g., setting all of the selected bits equal to zero), step 124. The number of bits in this selection will depend upon the address size implemented in the processor or operating system for which the binary image is intended. For example, 16, 32 or 64 bits may be selected and normalized. In some instructions register values are encoded within the instruction itself and not in subsequent bits, in which case the step of selecting and normalizing a block of bits selects those bits within the instruction that encode a register value.

Once the selected bits are normalized or if the code selected in step 120 did not correspond to a register or memory location reference (i.e., test 122=“No”), the process may continue by determining whether there is more binary code to be analyzed, test 126, and if so returning to select the next block of code for analysis, step 120. Once all the code has been so analyzed (i.e. test 126=“No”), processing may continue to the next step, such as step 14 as described above with reference to FIGS. 1 and 2.

As mentioned above, functional blocks can be identified within a binary image, step 14, by using a decompiler application or well known techniques for identifying the beginning and end of a function for a given compiler on a given processor, step 16, or by directly scanning the binary image under analysis to recognize instruction patterns that begin and end functions. An example of process steps that may be implemented to scan the binary image for function boundaries, step 14, is illustrated in FIG. 4. Since functions, and particularly component parts (e.g., segments demarcated by conditional instructions) may be nested within loops, the process of identifying functional blocks within a binary image may include the use of a loop counter i (or similar method of keeping track of nested and recursive loops within the binary image) which may be initialized to “0” at the start of the analysis, step 140. In this process, a block of binary code may be selected, step 142, with the code block sized in terms of bytes to correspond to the size of instructions associated with the beginning and ending of functions. As shown in FIG. 4, this process may be structured as a loop to work through the binary image under analysis. In the first pass through the loop the code block selected in step 142 will be the first X bytes within the binary image, while in subsequent passes through the analysis loop the code block selected in step 142 will be the next X bytes of code in the binary image beyond those processed in the previous pass. The selected block of binary code is then compared to the patterns for instructions that characterize the beginning of a function, such as loop-beginning instructions or branching-beginning instructions, test 144. Typically a function or branch will begin by pushing the instruction pointer onto a stack and branching to the function beginning instruction. Such instruction patterns can be easily recognized to determine the start of a function (i.e., identify a function start boundary).

If the start of a function is recognized (i.e., test 144=“Yes”), the bit sequence location of that instruction is stored in memory or marked with a function start marker, step 146. In order to accommodate nested functions, the particular function start marker may be identified with a loop counter value i, or other manner for keeping track of nested loops, which is then incremented, step 148, so that the start and end of nested functions can be accurately correlated. Processing can then continue by determining whether there is more binary code to be analyzed, test 156, and if so, returning to step 142 to select the next code block for analysis.

If the selected code block does not include the start of a function (i.e., test 144=“No”), the code block can be tested to determine whether it includes an instruction indicating the end of a function, test 150. Similar to the start of functions or branches, typical functions end by popping the instruction pointer (address sequencer value) off of a stack and branching back to the indicated instruction address. Such instruction patterns can be easily recognized to determine the end of the function (i.e., identify the function's end boundary). If the end of a function is identified (i.e., test 150=“Yes”), the particular function end marker may be correlated to a particular loop, step 152, such as by looking for an “upward” conditional branch, i.e., a branch whose address is less that the address of the branch instruction. Similarly, an “if” statement is downward conditional branch. The bit sequence location of that instruction is stored in memory or marked with a function end marker that is correlated with the associated loop-begin statement, step 152. In order to accommodate nested functions, a loop counter may also be incremented, step 154, so that the start and end of functions can be accurately tracked. Processing can then continue by determining whether there is more binary code to be analyzed, test 156, and if so, returning to step 142 to select the next code block for analysis. Once all of the binary image have been so analyzed (i.e., test 156=“No”), processing can then continue to the next step in the analysis, such as step 18 described above with reference to FIG. 1.

Instead of adding function beginning and ending tags to the binary image in steps 146 and 152, an address pointer may be stored in a database with the pointer indicating the particular location in the bit sequence of the binary image or in memory containing the bits associated with the beginning or ending of a function. Such a database of address pointers can simply be a table of memory locations which may be stored in pairs for indicating the start location and ending location of functions within the binary image. In subsequent processing such memory location can be used by a processor to select a functional block of the binary image for analysis (steps 18 or 19) by beginning to read the image at the memory location stored in the function beginning pointer and stopping the read process when the memory location stored in the function ending pointer is reached.

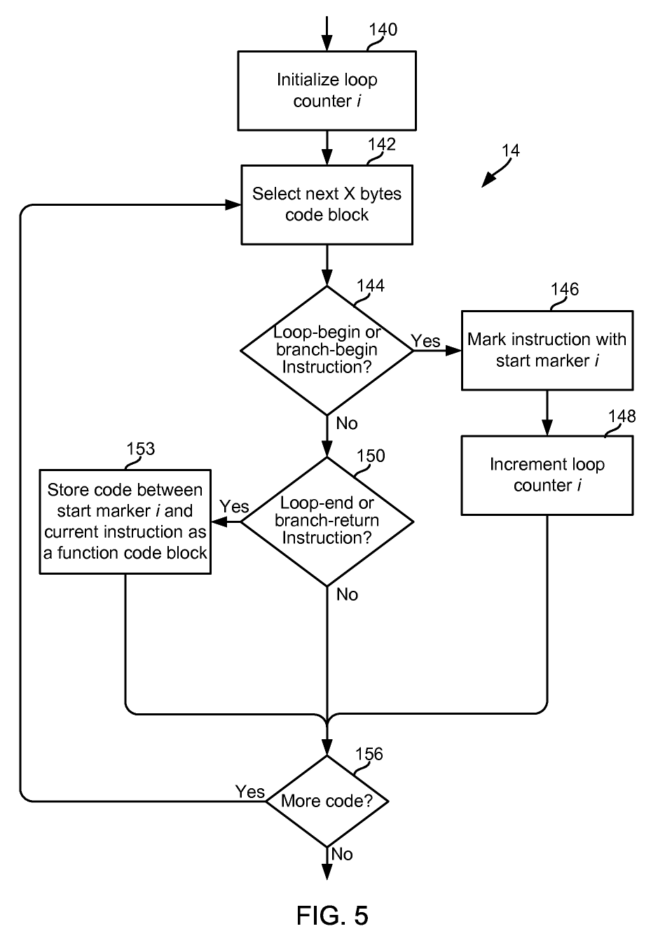

As mentioned above, identified functions may be stored separately in a temporary database (or similar data structure) instead of marking function boundaries in the binary image. An example of process steps that may be implemented to scan the binary image and store recognized functions in a database, step 14, is illustrated in FIG. 5. This alternative process is very similar to that described above with reference to FIG. 4 with the exception that when a function ending instruction is identified (i.e., test 150=“Yes”), the block of code extending between the function beginning instruction recognized in step 146 and the function ending instruction recognized in test 150 is stored in memory as a function code block, step 153. The database in which the function code block is stored may be organized in a variety of well-known data structures, and may include an indication of where in the binary image the function began (e.g., the bit sequence location of the instruction first recognized in test 144) so functions can be selected (e.g., in steps 18 or 19) in the order in which they appear in the binary image. Doing so accommodates situations where functions are nested within each other, in which case the function ending instructions may appear in a sequence different from that in which the function beginning instructions appear. Once the recognized function code block has been stored, the process may then continue by determining whether there is more code to be analyzed, test 156, and if so, returning to step 142 to select the next code block for analysis. Once all of the binary image has been so analyzed (i.e., test 156=“No”), processing can then continue to the next step in the analysis, such as step 18 described above with reference to FIG. 1.

It will be appreciated by one of skill in the art that functions often call or include other functions. The embodiments described above will accommodate both stand alone functions, functions nested within another function, and functions of functions. In the case of nested functions, multiple function matches may be obtained, as may be the case when a function included within the reference function image database 22 contains both a function comprising other functions and one or more of those included functions. For example, if the reference function image database 22 includes a reference Viterbi decoder function and a reference modem control function which includes that same Viterbi decoder function, a match to both reference functions would be determined when the binary image under analysis includes that particular modem control function.

In an embodiment, the processing in steps 12 and 14 illustrated in FIGS. 3 and 4 can be combined to proceed in a single loop. In this embodiment, each block of code selected in steps 120 or 142 is analyzed to determine if it contains either a register label or memory address reference, test 122, and if not, the same code block is analyzed to determine if it contains a loop-begin or branch-begin instruction, test 144, or a loop-end or branch-return instruction, test 150. If any test is positive (i.e., any one of tests 122, 144 or 150=“Yes”), the associated processing is accomplished (i.e., one of steps 124, 146, 152 or 153) and the loop continued by determining if more code remains to be analyzed (tests 126, 156), and if so, selecting the next block of code (i.e., repeating steps 120 or 142). This embodiment permits the preprocessing of the binary image to be accomplished in a single pass.

The embodiments described above are well-suited for determining whether particular versions of functions are included within a software build since the method recognizes exact or near exact matches to function images in the reference database 22. These embodiments may be very useful for confirming the contents of a software binary image before release or in identifying known bugs that may exist within a binary image.

In other situations or applications, it may be desirable to determine whether any binary image is likely to include certain functions. An example of such a situation is when software is analyzed to determine whether any functions have been copied without authorization. In such situations, looking for exact matches can render the method vulnerable to efforts to conceal copying by including inconsequential modifications in the function code. To address such situations the likely match embodiment method compares the binary image under analysis to a reference database at the level of component parts within functions to determine if parts of a function match known function implementations.

By analyzing the binary image under analysis in smaller function-component segments, like function component parts can be matched to reference component parts within functions in the reference database which can be used to determine the degree to which the binary image under analysis is functionally similar to reference functions and known function implementations. By presenting the matched component part information in statistical or graphical metrics, the likely match embodiment method can inform users as to the likelihood that the binary image under analysis includes copied software. Even though the results are not absolute, such likelihood assessments may be useful in determining whether more rigorous analysis methods, such as bit-by-bit comparisons of binary images or line-by-line comparisons of source code, are worth performing. Thus, the likely match embodiment method can be used as a screening tool to compare binary images to a large number of known implementations to determine if further investigation is appropriate.

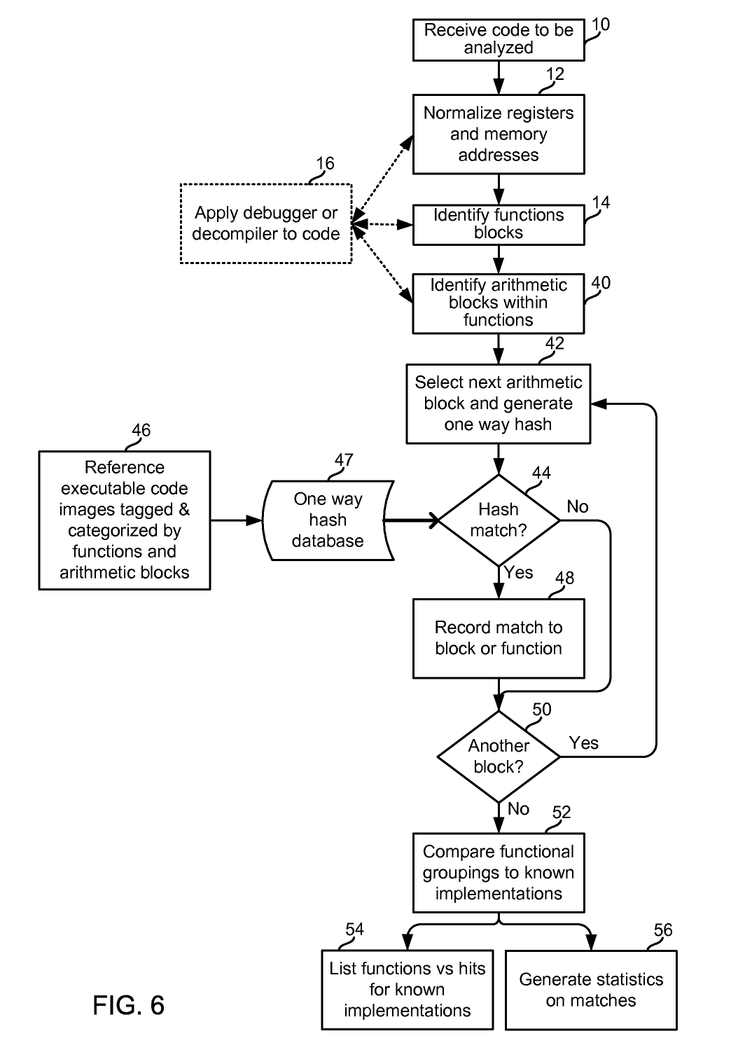

Example process steps that may be implemented in the likely match embodiment method are illustrated in FIG. 6. As described above with reference to FIGS. 1 and 2, a binary image that is received for analysis, step 10, is preprocessed to normalize registers and memory address references, step 12, and identify function blocks, step 14. As discussed above, this preprocessing enables the comparison of functions and function component parts without the distraction of register and memory address values which will vary from build to build. To analyze the binary image at a finer level of detail than afforded by the embodiments described above, the preprocessing continues by identifying component parts within functions, such as arithmetic and similar component blocks, step 40. A variety of criteria can be used for identifying the boundaries of component parts within functions in step 40, so this further segmentation is not limited to arithmetic blocks alone—the use of “arithmetic block” in the figures is for illustration purposes only. Such component parts of functions may be identified using a decompiler application or well known techniques for identifying the beginning and end of a function for a given compiler on a given processor, step 16, since a decompiler and other techniques can identify branches, conditional statements and similar instructions. Alternatively, a block-by-block analysis of the binary image can be performed in the manner described above with reference to FIGS. 4 and 5 to identify the start and end of significant components within a function. For example, many functions include conditional statements which can be recognized based upon their unique bit pattern. Component parts within functions may also be recognized from branching instructions, which can be recognized based on their bit pattern or based upon an instruction pushing an instruction sequencer value onto a stack with the end of the component part indicated by popping that sequencer value off the stack.

In identifying component parts in step 40, the components may be individually identified, or they may be identified as corresponding to the particular function of which they are part. Either approach will work and each approach has advantages and disadvantages that may make one approach superior in certain applications or circumstances.

Similar to the manner in which functions can be identified or stored in a temporary database as described above with reference to FIGS. 4 and 5, the identified component parts of functions may either be identified, such as by beginning and ending markers added to the binary image, storing pointers indicating the beginning and ending bits within the binary image, or storing the identified component part code blocks in a temporary database.

With functions and their component parts identified or stored in a database, the processing can proceed by selecting a component part for analysis, step 42. As shown in FIG. 6, this processing can be performed in a loop to work through the binary image under analysis. In the first pass through the analysis loop the block of code selected in step 42 will be the first within the binary sequence or within the temporary database, while in subsequent passes through the analysis loop the next block of code selected in step 42 will be the next in the binary sequence or database. In an embodiment, the selected component part or arithmetic block of code may be compared to reference component parts stored in a component part reference database 46 using a bit-by-bit comparison method for test 20 as described above with reference to FIG. 1. However, given the large volume of comparisons that may need to be made when a binary image is broken into component parts rather than functions, particularly when each component part is compared to a large library of reference component part binary images, a preferred embodiment generates a one-way hash of the selected component part or arithmetic block in step 42. That generated hash can then be compared to reference component part hash values that may be stored in a component hash database 47 in test 44. As described above with reference to FIG. 2, a database of component part hash values may be generated in advance of the analysis and maintained in a library or database for use with the embodiment methods. As mentioned above, comparing hash values involves much less processing than comparing binary code bit-by-bit or recognizing patterns in binary sequences, and therefore many more component parts can be compared to a reference database within a given amount of processing time using this method.

If the hash value for the selected component part block of code generated in step 42 matches a hash value within the reference component part hash database 47 (i.e., test 44=“Yes”), that match is recorded, step 48. Depending upon the implementation, the matching component part may be recorded alone or in combination with the function of which it is a component. In other words, depending upon the way in which the component part hash database 47 is organized, the process can keep track of matched component parts alone or component parts matched within particular functions. Since many arithmetic blocks may be used in a variety of different functions, the matching of such arithmetic blocks within a binary image may be of less significance than the matching of such arithmetic blocks in a particular function. On the other hand, a match of a very unique arithmetic block at any location within a binary image may indicate a likelihood that at least portions of the software have been copied including the matched unique arithmetic block. In a further embodiment, only the fact that a match has been detected may be recorded, such as in the form of a match counter. For example, a percentage of matching component (i.e. the percentage of all component blocks that match to component's within the component hash database 47) may be calculated simply by counting the number of matches and the number of component blocks compared.

If the selected component part does not match any hash values in the hash database 47 (i.e., test 44=“No”) or a detected match has been recorded, step 48, the process made proceed by determining whether there is another component part or arithmetic block to analyze, test 50, and if so, returning to step 42 to select the next component part block of code and generate its hash value.

Once all component parts have been analyzed (i.e., test 50=“No”), the recorded matches may be used to compare the matching functional groupings to known implementations, step 52. A variety of different analyses may be performed using the recorded match results in order to reach conclusions regarding the content of the binary image. For example, a straight percentage of matching component parts may be generated for the overall binary image, with the output provided as a statistical measure, step 56. Such a statistic would reveal information related to the likelihood that the overall binary image is based upon a copy of a similar software application. However, if a binary image contains only a few functions that were copied, such a global percentage statistic might not reveal the copying. For that reason, the groupings of component matches to functions may be compared in step 52 to identify functions for which a large percentage of component parts match those in reference functions within the reference database 22, 46. If a large percentage of component parts within a function match those in a reference function in the reference database 22, 46, this may indicate a high likelihood that that particular function has been copied. This also may be presented as a statistic showing the component part matches within particular functions, step 56.

In a more detailed analysis, the order in which matching component parts appear within a function may be assessed in step 52. Often times the order in which component processes are performed does not affect the overall function, and thus the number of component parts in a function which match reference component parts within the reference database 22, 46 may be sufficient to indicate copying. However, for some functions, the order in which component parts are performed is significant. For such functions a large number of matching component parts may not indicate that copying is likely if the order in which they appear in the function within the binary image under analysis is different from that within the reference function(s) within the reference database 22, 46. Such information may be presented to the user in a form which identifies particular reference functions and manner in which the component parts are matched to known implementations, step 54.

In a further analysis of component part matching results, the results may be presented in the form of a histogram that can reveal the frequency at which particular component parts within the binary image under analysis appear in various reference functions. This approach may be useful for component parts that appear in many different functions or for detecting an overall pattern of copying.

In a further example, the appearance of particular component parts within a function or a number of functions may be unique to a particular implementation, and thus their matches may indicate a high likelihood of copying. Such analysis may be output as either a comparison to known implementations, step 54, or as a statistical match, step 56.

In a further example, the order in which component parts appear within a binary image under analysis or within particular functions within that binary image may be compared to known implementations. Functions are often called in a hierarchy, and therefore, a hierarchy of functional calls can be unique to a particular function or software release. In situations where there may be many matching functions or many matching function component parts, the sequence in which the component parts or functions are called may provide a better sense of the likelihood that the software has been copied. Thus, the probability of copying may be related to the sequence in which common functions and component parts are called within a given binary image.

These various analyses in step 52 may make use of a variety of well-known logical and statistical processes, including, for example, Bayesian statistical analysis, to generate a measure of likelihood of copying.

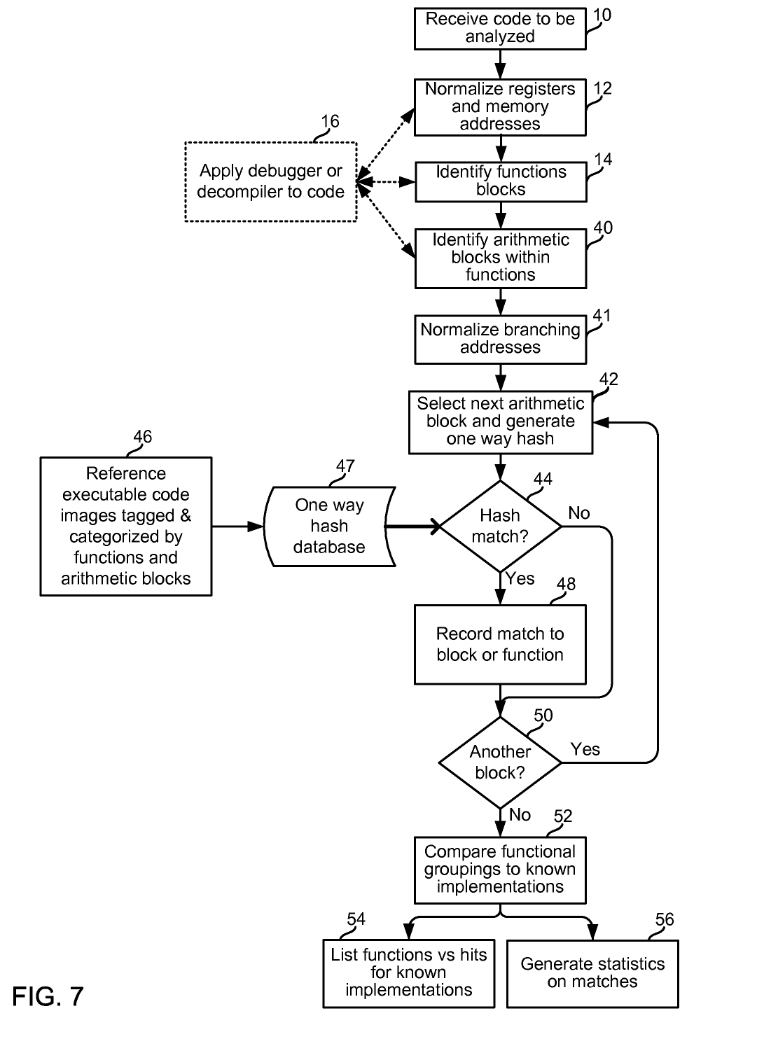

An alternative embodiment is illustrated in FIG. 7 which includes additional preprocessing in order to normalize branching addresses. Normalization of branching functionality may be accomplished after the function and algorithmic blocks have been identified. Branching addresses can be normalized by either setting the addresses to zero or calculating a relative address, using zero as the base address of the function or algorithmic block. The latter process may be more accurate in some situations. In order to be better able to detect component parts of functions which are presented in an order different from those within a reference database, the binary image under analysis may be further preprocessed to normalize the branching addresses, step 41. As noted above, branching within functions may be used to detect arithmetic blocks and component parts in step 40. When such branching is detected, branching addresses included with such instructions may be set to a standard value in step 41, such as all zeros or set to a calculated relative address relative a zero base address of the function or algorithmic block, so that the resulting normalized block of code can be compared without regard to branching addresses. Other than the addition of step 41 for normalizing branching addresses, the processing of the steps in this embodiment proceed as described above with reference to FIG. 6.

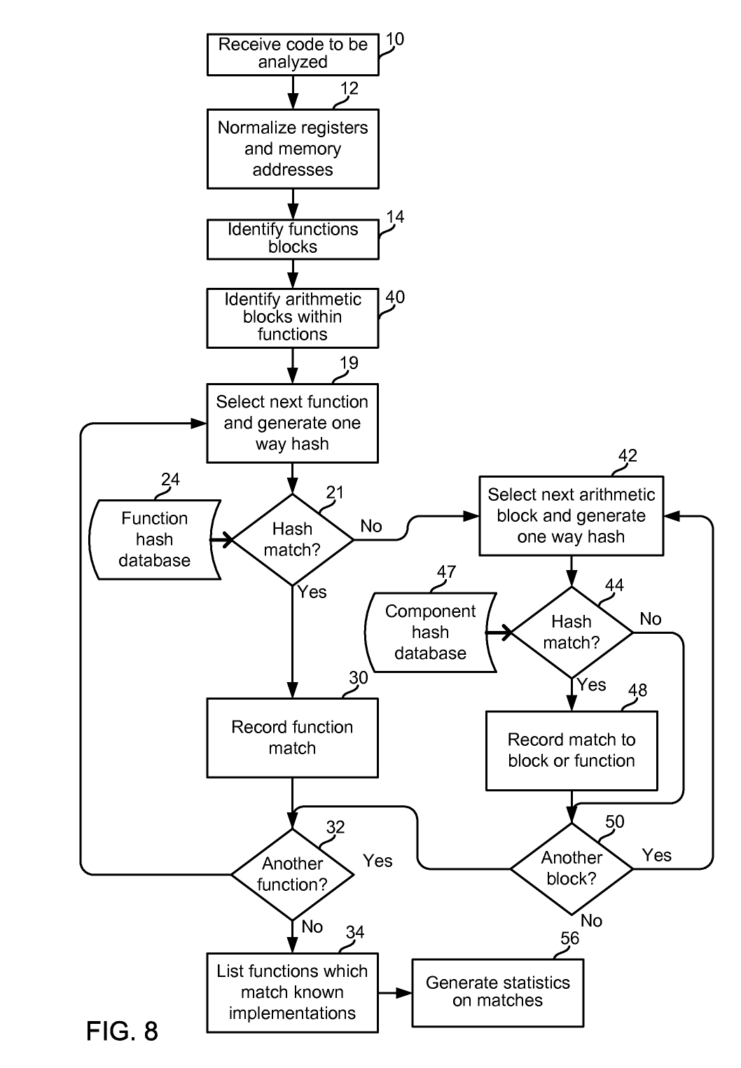

In a further embodiment illustrated in FIG. 8, the exact match and likely match embodiments may be combined into a single process. In this embodiment, a function block of code may be selected, step 18 or 19, and compared at the functional level to the reference database 22 in tests 20 or 21. That comparison may be made based on their bit patterns, test 20, as described above with reference to FIG. 1, or based upon comparing hash values, test 21, as described above with reference to FIG. 2. If a match is detected, the processing may continue as described above with reference to FIGS. 1 and 2. However, if a function match is not detected, the process in this embodiment may continue by selecting a component part, such as an arithmetic block, within that function, step 42. That selected component part may then be compared to a reference database 46 of reference function component parts, test 44. If a match is detected (i.e., the hash values are equal), that may be recorded, step 48, and the process continued by selecting the next component part within the selected function, repeating step 42, if test 50 indicates there are more component parts within the function (i.e., test 50=“Yes”). It is noted that if a selected function matches a reference function in the reference database 22, there is no need to perform the component part matching analysis of steps 42-50. Once all component parts of a function have been analyzed, if there are more functions to be analyzed (i.e., test 32=“Yes”), the process returns to select the next function block of code, repeating step 18 or 19. The preprocessing, steps 10-14 and 40-42, and that presentation of results, steps 34, 56, in this combined embodiment implement the processes described above with reference to FIGS. 1-2 and 6-7. This combined embodiment enables detecting both exact functional matches and likely function copying in a single analysis of a software binary image.

In a further alternative to the embodiment illustrated in FIG. 8 the process of identifying arithmetic blocks or component parts within a function, step 42, may only be performed if the function does not match a function in the reference function hash database 24 (i.e., test 21=“No”). In this alternative embodiment, step 40 will be performed just prior to step 42 and be limited to the function selected in step 19. Otherwise, the processing of this embodiment will precede substantially the same as described above with reference to FIG. 8.

The various embodiments may have a number of useful applications. As mentioned above, one application is for screening binary images prior to release to confirm that they do not include known bugs or outdated software modules. Since this processing can be accomplished after the code is compiled and converted into an executable binary image, this check does not rely upon software source tracking or other expensive methods used for tracking the contents of binary images. Another application involves using the methods to recognize particular functions or software modules to diagnose operational problems or determine the source of bugs within a particular binary image. A further application is the use of the methods to confirm that a binary image does not include functions or software modules written by third parties, such as public resource software or software for which a license is not available. Also, as described above, the methods can be used to detect unauthorized copying of software or functions. In this regard, the methods can be used as a screening tool to identify software that may include copied functions for which further analysis may be appropriate.

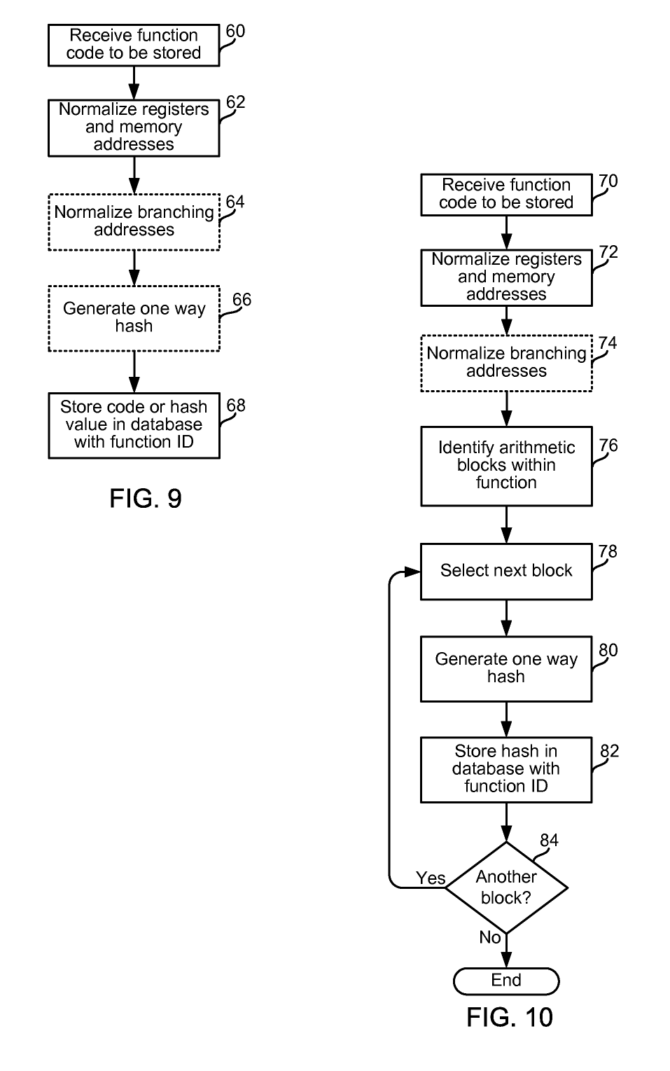

Reference databases 22 of known function images can be generated using the same preprocessing steps as described above with reference to FIGS. 1 and 2. As illustrated in FIG. 9, an executable function binary image to be added to a reference database 22 may be received by a processing computer, step 60, such as in the form of a tangible storage medium (e.g., a CD, DVD or external hard drive) or via a network. This received function should be in the executable compiled form similar to the form in which it might appear in a binary image under analysis. Since the binary image may vary from compiler to compiler, in an embodiment, the function may be compiled with a variety of compiler brands and complier versions to generate a range of binary images that may be encountered. Each received function binary image is then analyzed to normalize registers and memory address references, step 62, using the same methods as in step 12 described above with reference to FIG. 1. The normalizing values to which the address and registers are set should be the same as those used in analyzing a binary image, such as setting all addresses to zero. If branching addresses are normalized in the analysis as described above with reference to step 41 shown in FIG. 7, the received function should also have its branching addresses normalized, optional step 64. If binary images are to be analyzed for function content by comparing hash values, the hash algorithm is applied to the normalized function to generate its hash value, optional step 66. Finally, the normalized code or the hash value is stored in the reference database, step 68. This reference database can be structured using any well-known data structure and may include an identifier (ID) for the particular function so that if a match is detected, the matching function can be easily identified.

A reference database of function component parts can be generated in a similar manner. As illustrated in FIG. 10, a function binary image to be stored in the reference database can be received in a computer in any of the formats described above, step 70. Since the binary image may vary from compiler to compiler, in an embodiment, the function may be compiled with a variety of compiler brands and complier versions to generate a range of binary images that may be encountered. The received function binary image is then preprocessed to normalize memory registers and memory address references, step 72, and to identify component part or arithmetic block boundaries within the received function, step 74. With the component parts identified, the first component part block of code is selected, step 76. The hash algorithm is applied to the selected component part block of code to generate its hash value, step 78, which is stored in a component hash database, step 80. This database may be structured using any well-known data structure and may include an ID for the particular function and component part so that if a match is detected the matching function and component part can be easily identified. The process may continue by determining whether there is another component part or arithmetic block within the function, test 82, and if so, selecting the next component part block of code to generate a hash value for storage in the hash database, repeating step 76, 78 and 80. Once all component parts have been processed (i.e., test 82=“No”), the processing of this function is completed.

While a reference database 22, 24, 46, 47 can be constructed one function at a time, whole software binary images may also be loaded, in which case the processing illustrated in FIGS. 9 and 10 will include the step of identifying functions, step 14, as described above with reference to FIGS. 1, 4 and 5. In this manner, a library can quickly be generated for all software binary images which have been released by sequentially feeding them into a computer configured to perform the methods illustrated in FIGS. 9 and 10.

Library databases of reference functions and reference function component parts may be generated by storing images of new functions as they are approved for release. In this manner the databases can be built up over time to reflect all software releases by a user company.

A variety of different reference databases may be generated and used to support the various uses of the embodiment methods. For example, one reference database may include only the binary images of functions with known bugs for use in screening software releases to confirm they do not include such known problems. Another reference database may include all authorized software releases for a company for use in screening software released by others to detect unauthorized copying. A further reference database may include all outdated function images for use in screening software releases to confirm that they do not include outdated software modules.

The embodiments described above may also be implemented on a personal computer 160 illustrated in FIG. 11. Such a personal computer 160 typically includes a processor 161 coupled to volatile memory 162 and a large capacity nonvolatile memory, such as a disk drive 163. The computer 180 may also include a floppy disc drive 164 and a CD/DVD drive 165 coupled to the processor 161. Typically the computer 160 will also include a user input device like a keyboard 166 and a display 137. The computer 160 may also include a number of connector ports for receiving external memory devices coupled to the processor 161, such as a universal serial bus (USB) port (not shown), as well as network connection circuits (not shown) for coupling the processor 161 to a network.

The various embodiments may be implemented by a computer processor 161 executing software instructions configured to implement one or more of the described methods. Such software instructions may be stored in memory 162, 163 as separate applications, or as compiled software implementing an embodiment method. Reference database may be stored within internal memory 162, in hard disc memory 164, on tangible storage medium or on servers accessible via a network (not shown). Further, the software instructions and databases may be stored on any form of tangible processor-readable memory, including: a random access memory 162, hard disc memory 163, a floppy disc (readable in a floppy disc drive 164), a compact disc (readable in a CD drive 165), read only memory, FLASH memory, electrically erasable programmable read only memory (EEPROM), and/or a memory module (not shown) plugged into the computer 160, such as an external memory chip or a USB-connectable external memory (e.g., a “flash drive”).

Those of skill in the art would appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The order in which the steps of a method described above and shown in the figures is for example purposes only as the order of some steps may be changed from that described herein without departing from the spirit and scope of the present invention and the claims. The steps of a method or algorithm described in connection with the embodiments disclosed herein may be embodied directly in hardware, in a software module executed by a processor, or in a combination of the two. A software module may reside in processor readable memory which may be any of RAM memory, flash memory, ROM memory, EPROM memory, EEPROM memory, registers, hard disk, a removable disk, a CD-ROM, or any other form of storage medium known in the art. An exemplary storage medium is coupled to a processor such that the processor can read information from, and write information to, the storage medium. In the alternative, the storage medium may be integral to the processor. The processor and the storage medium may reside in an ASIC. The ASIC may reside in a user terminal or mobile device. In the alternative, the processor and the storage medium may reside as discrete components in a user terminal or mobile device. Additionally, in some aspects, the steps and/or actions of a method or algorithm may reside as one or any combination or set of codes and/or instructions on a machine readable medium and/or computer readable medium, which may be incorporated into a computer program product.

The foregoing description of the various embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, and instead the claims should be accorded the widest scope consistent with the principles and novel features disclosed herein.

What is claimed is:

1. A method for analyzing a software binary image, comprising:
normalizing memory registers and memory address references within the software binary image; and
comparing the normalized binary image to a reference binary image to determine if there is a match.

2. The method of claim 1, further comprising normalizing branching addresses within the software binary image.

3. A computer, comprising:
a processor; and
a memory coupled to the processor,
wherein the processor is configured with software instructions to perform steps comprising:
normalizing memory registers and memory address references within the software binary image; and
comparing the normalized binary image to a reference binary image to determine if there is a match.

4. The computer of claim 3, wherein the processor is configured with software instructions to perform steps further comprising normalizing branching addresses within the software binary image.

5. A computer, comprising:
means for normalizing memory registers and memory address references within the software binary image; and
means for comparing the normalized binary image to a reference binary image to determine if there is a match.

6. The computer of claim 3, further comprising comparing means for normalizing branching addresses within the software binary image.

7. A tangible storage medium having stored thereon processor-executable software instructions configured to cause a processor of a computer to perform steps comprising:
normalizing memory registers and memory address references within the software binary image; and
comparing the normalized binary image to a reference binary image to determine if there is a match.

8. The tangible storage medium of claim 7, wherein the tangible storage medium has stored thereon processor-executable software instructions configured to cause a processor of a computer to perform steps further comprising normalizing branching addresses within the software binary image.

9. A method for analyzing a software binary image, comprising:
normalizing memory registers and memory address references within the software binary image to generate a normalized binary image;
identifying functions within the normalized binary image; and
comparing each identified function in the normalized binary image to a reference binary image to determine if there is a match.

10. The method of claim 9, wherein the step of comparing comprises comparing each identified function in the normalized binary image to each of a plurality of reference binary images to determine if there is a match to any one of the plurality of reference binary images.

11. The method of claim 9, wherein the step of comparing comprises:
selecting one of the identified functions within the normalized binary image; and
comparing the selected one of the identified functions to the reference binary image by comparing a bit pattern in the selected one of the identified functions to a bit pattern in the reference binary image to determine if there is a match.

12. The method of claim 5, further comprising:
selecting a next one of the identified functions within the normalized binary image; and
comparing the selected next one of the identified functions to the reference binary image by comparing a bit pattern in the selected next one of the identified functions to a bit pattern in the reference binary image to determine if there is a match.

13. The method of claim 9, wherein the step of comparing comprises:
selecting one of the identified functions within the normalized binary image;
applying a hash algorithm to the selected one of the identified functions to generate a first hash value; and
comparing the first hash value to a first reference hash value to determine if there is a match, wherein the first reference hash value was generated by applying the hash algorithm to the reference binary image.

14. The method of claim 13, further comprising:
selecting a next one of the identified functions within the normalized binary image;
applying the hash algorithm to the selected next one of the identified functions to generate a second hash value; and
comparing the second hash value to the first reference hash value to determine if there is a match.

15. The method of claim 13, wherein the step of comparing the first hash value to the first reference hash value comprises comparing the first hash value to each of a plurality of reference hash values to determine if there is a match to any one of the plurality of reference hash values, wherein the plurality of hash values were generated by applying the hash algorithm to each of a plurality of reference binary images.

16. The method of claim 9, further comprising:
identifying component parts within at least one of the identified functions;
selecting a first one of the identified component parts;
applying a hash algorithm to the selected first one of the identified component parts to generate a component hash value; and
comparing the component hash value to a reference component hash value to determine if there is a match, wherein the reference component hash value was generated by applying the hash algorithm to a component part of the reference binary image.

17. The method of claim 13, further comprising:
identifying component parts within at least one of the identified functions;
selecting a first one of the identified component parts;
applying the hash algorithm to the selected first one of the identified component parts to generate a component hash value; and
comparing the component hash value to a reference component hash value to determine if there is a match, wherein the reference component hash value was generated by applying the hash algorithm to a component part of the reference binary image.

18. The method of claim 9, further comprising normalizing branching addresses within the normalized binary image.

19. A method for analyzing a software binary image, comprising:
normalizing memory registers and memory address references within the software binary image to generate a normalized binary image;
identifying functions within the normalized binary image;
identifying component parts within each of the identified functions;
selecting one of the identified functions within the normalized binary image;
selecting one of the identified component parts within the selected one of the identified functions;
applying the hash algorithm to the selected one of the identified component parts to generate a component hash value; and
comparing the component hash value to a reference hash value to determine if there is a match, wherein the reference hash value was generated by applying the hash algorithm to a component part of a reference function binary image.

20. The method of claim 19, wherein the step of comparing the component hash value to a reference hash value comprises comparing the component hash value to each of a plurality of reference hash values to determine if there is a match to any one of the plurality of reference hash values, wherein the plurality of reference hash values were generated by applying the hash algorithm to each component part of a plurality of reference binary images.

21. The method of claim 19, further comprising normalizing branching addresses within the normalized binary image.

22. The method of claim 19, wherein the steps of selecting one of the identified component parts within the selected one of the identified functions, applying the hash algorithm to the selected one of the identified component parts to generate a component hash value, and comparing the component hash value to a reference hash value are repeated until each component hash value for each one of the component parts of the selected one of the identified functions has been compared to the reference hash value.

23. The method of claim 22, wherein the step of selecting one of the identified functions within the normalized binary image is repeated until all component hash values for each one of the component parts of each one of the identified functions within the normalized binary image has been compared to the reference hash value.

24. The method of claim 23, wherein the step of comparing the component hash value to a reference hash value comprises comparing the component hash value to each of a plurality of reference hash values to determine if there is a match to any one of the plurality of reference hash values, wherein the plurality of reference hash values were generated by applying the hash algorithm to each component part of a plurality of reference binary images.

25. The method of claim 24, further comprising providing an output identifying a number of component hash values which match one or more reference hash values.

26. The method of claim 25, wherein the output is a percentage of component parts that match component parts within a reference function.

27. The method of claim 19, further comprising providing an output comparing an order of matched component parts within a selected function to an order of matched component parts within a reference function.

28. A computer, comprising:
a processor; and
a memory coupled to the processor,
wherein the processor is configured with software instructions to perform steps comprising:
normalizing memory registers and memory address references within a software binary image to generate a normalized binary image;
identifying functions within the normalized binary image; and
comparing each identified function in the normalized binary image to a reference binary image to determine if there is a match.

29. The computer of claim 28, wherein the processor is configured with software instructions such that the step of comparing comprises comparing each identified function in the normalized binary image to each of a plurality of reference binary images to determine if there is a match to any one of the plurality of reference binary images.

30. The computer of claim 28, wherein the processor is configured with software instructions such that the step of comparing comprises:
selecting one of the identified functions within the normalized binary image; and
comparing the selected one of the identified functions to the reference binary image by comparing a bit pattern in the selected one of the identified functions to a bit pattern in the reference binary image to determine if there is a match.

31. The computer of claim 30, wherein the processor is configured with software instructions to perform steps further comprising:
selecting a next one of the identified function within the normalized binary image; and
comparing the selected next one of the identified functions to the reference binary image by comparing a bit pattern in the selected next one of the identified functions to a bit pattern in the reference binary image to determine if there is a match.

32. The computer of claim 28, wherein the processor is configured with software instructions such that the step of comparing comprises:
selecting one of the identified functions within the normalized binary image;
applying a hash algorithm to the selected one of the identified functions to generate a first hash value; and
comparing the first hash value to a first reference hash value to determine if there is a match, wherein the first reference hash value was generated by applying the hash algorithm to the reference binary image.

33. The computer of claim 32, wherein the processor is configured with software instructions to perform steps further comprising:
selecting a next one of the identified functions within the normalized binary image;
applying the hash algorithm to the selected next one of the identified functions to generate a second hash value; and
comparing the second hash value to the first reference hash value to determine if there is a match.

34. The computer of claim 32, wherein the processor is configured with software instructions such that the step of comparing the first hash value to a reference hash value comprises comparing the first hash value to each of a plurality of reference hash values to determine if there is a match to any one of the plurality of reference hash values, wherein the plurality of hash values were generated by applying the hash algorithm to each of a plurality of reference binary images.

35. The computer of claim 28, wherein the processor is configured with software instructions to perform steps further comprising:
identifying component parts within at least one of the identified functions;
selecting a first one of the identified component parts;
applying a hash algorithm to the selected first one of the identified component parts to generate a component hash value; and
comparing the component hash value to a reference hash value to determine if there is a match, wherein the reference component hash value was generated by applying the hash algorithm to a component part of the reference binary image.

36. The computer of claim 32, wherein the processor is configured with software instructions to perform steps further comprising:
identifying component parts within at least one of the identified functions;
selecting a first one of the identified component parts;
applying the hash algorithm to the selected first one of the identified component parts to generate a component hash value; and
comparing the component hash value to a second reference hash value to determine if there is a match, wherein the reference component hash value was generated by applying the hash algorithm to a component part of the reference binary image.

37. The computer of claim 28, wherein the processor is configured with software instructions to perform steps further comprising normalizing branching addresses within the normalized binary image.

38. A computer, comprising:
a processor; and
a memory coupled to the processor,
wherein the processor is configured with software instructions to perform steps comprising:
normalizing memory registers and memory address references within the software binary image to generate a normalized binary image;
identifying functions within the normalized binary image;
identifying component parts within each of the identified functions;
selecting one of the identified functions within the normalized binary image;
selecting one of the identified component parts within the selected one of the identified functions;
applying the hash algorithm to the selected one of the identified component parts to generate a component hash value; and
comparing the component hash value to a reference hash value to determine if there is a match, wherein the reference hash value was generated by applying the hash algorithm to a component part of a reference function binary image.

39. The computer of claim 38, wherein the processor is configured with software instructions such that the step of comparing the component hash value to a reference hash value comprises comparing the component hash value to each of a plurality of reference hash values to determine if there is a match to any one of the plurality of reference hash values, wherein the plurality of reference hash values were generated by applying the hash algorithm to each component part of a plurality of reference binary images.

40. The computer of claim 38, wherein the processor is configured with software instructions to perform steps further comprising normalizing branching addresses within the normalized binary image.

41. The computer of claim 38, wherein the processor is configured with software instructions such that the steps of selecting one of the identified component parts within the selected one of the identified functions, applying the hash algorithm to the selected one of the identified component parts to generate a component hash value, and comparing the component hash value to a reference hash value are repeated until each component hash value for each one of the component parts of the selected one of the identified functions has been compared to the reference hash value.

42. The computer of claim 41, wherein the processor is configured with software instructions such that the step of selecting one of the identified functions within the normalized binary image is repeated until all component hash values for each one of the component parts of each one of the identified functions within the normalized binary image has been compared to the reference hash value.

43. The computer of claim 42, wherein the processor is configured with software instructions such that the step of comparing the component hash value to a reference hash value comprises comparing the component hash value to each of a plurality of reference hash values to determine if there is a match to any one of the plurality of reference hash values, wherein the plurality of reference hash values were generated by applying the hash algorithm to each component part of a plurality of reference binary images.

44. The computer of claim 43, wherein the processor is configured with software instructions to perform steps further comprising providing an output identifying a number of component hash values which match one or more reference hash values.

45. The computer of claim 44, wherein the processor is configured with software instructions to perform steps such that the output is a percentage of component parts that match component parts within a reference function.

46. The computer of claim 38, wherein the processor is configured with software instructions to perform steps further comprising providing an output comparing an order of matched component parts within a selected function to an order of matched component parts within a reference function.

47. A computer, comprising:
means for normalizing memory registers and memory address references within a software binary image to generate a normalized binary image;
means for identifying functions within the normalized binary image; and
means for comparing each identified function in the normalized binary image to a reference binary image to determine if there is a match.

48. The computer of claim 47, wherein means for comparing comprises means for comparing each identified function in the normalized binary image to each of a plurality of reference binary images to determine if there is a match to any one of the plurality of reference binary images.

49. The computer of claim 47, wherein means for comparing comprises:
means for selecting one of the identified functions within the normalized binary image; and
means for comparing the selected one of the identified functions to the reference binary image by comparing a bit pattern in the selected one of the identified functions to a bit pattern in the reference binary image to determine if there is a match.

50. The computer of claim 49, further comprising:
means for selecting a next one of the identified function within the normalized binary image; and
means for comparing the selected next one of the identified functions to the reference binary image by comparing a bit pattern in the selected next one of the identified functions to a bit pattern in the reference binary image to determine if there is a match.

51. The computer of claim 47, wherein means for comparing comprises:
means for selecting one of the identified functions within the normalized binary image;
means for applying a hash algorithm to the selected one of the identified functions to generate a first hash value; and
means for comparing the first hash value to a first reference hash value to determine if there is a match, wherein the first reference hash value was generated by applying the hash algorithm to the reference binary image.

52. The computer of claim 51, further comprising:
means for selecting a next one of the identified functions within the normalized binary image;
means for applying the hash algorithm to the selected next one of the identified functions to generate a second hash value; and
means for comparing the second hash value to the first reference hash value to determine if there is a match.

53. The computer of claim 51, wherein means for comparing the first hash value to a reference hash value comprises means for comparing the first hash value to each of a plurality of reference hash values to determine if there is a match to any one of the plurality of reference hash values, wherein the plurality of hash values were generated by applying the hash algorithm to each of a plurality of reference binary images.

54. The computer of claim 47, further comprising:
means for identifying component parts within at least one of the identified functions;
means for selecting a first one of the identified component parts;
means for applying a hash algorithm to the selected first one of the identified component parts to generate a component hash value; and
means for comparing the component hash value to a reference hash value to determine if there is a match, wherein the reference component hash value was generated by applying the hash algorithm to a component part of the reference binary image.

55. The computer of claim 51, further comprising:
means for identifying component parts within at least one of the identified functions;
means for selecting a first one of the identified component parts;
means for applying the hash algorithm to the selected first one of the identified component parts to generate a component hash value; and
means for comparing the component hash value to a second reference hash value to determine if there is a match, wherein the reference component hash value was generated by applying the hash algorithm to a component part of the reference binary image.

56. The computer of claim 47, further comprising means for normalizing branching addresses within the normalized binary image.

57. A computer, comprising:
means for normalizing memory registers and memory address references within a software binary image to generate a normalized binary image;
means for identifying functions within the normalized binary image;
means for identifying component parts within each of the identified functions;
means for selecting one of the identified functions within the normalized binary image;
means for selecting one of the identified component parts within the selected one of the identified functions;
means for applying the hash algorithm to the selected one of the identified component parts to generate a component hash value; and
means for comparing the component hash value to a reference hash value to determine if there is a match, wherein the reference hash value was generated by applying the hash algorithm to a component part of a reference function binary image.

58. The computer of claim 57, wherein the means for comparing the generated hash value to a reference hash value comprises means for comparing the component hash value to each of a plurality of reference hash values to determine if there is a match to any one of the plurality of reference hash values, wherein the plurality of reference hash values were generated by applying the hash algorithm to each component part of a plurality of reference binary images.

59. The computer of claim 57, further comprising means for normalizing branching addresses within the normalized binary image.

60. The computer of claim 57, further comprising means for repeatedly implementing the means for selecting one of the identified component parts within the selected one of the identified functions, means for applying the hash algorithm to the selected one of the identified component parts to generate a component hash value, and means for comparing the component hash value to a reference hash value until each component hash value for each one of the component parts of the selected one of the identified functions has been compared to the reference hash value.

61. The computer of claim 60, further comprising means for repeatedly implementing the means for selecting one of the identified functions within the normalized binary image until all component hash values for each one of the component parts of each one of the identified functions within the normalized binary image has been compared to the reference hash value.

62. The computer of claim 61, wherein the means for comparing the component hash value to a reference hash value comprises means for comparing the component hash value to each of a plurality of reference hash values to determine if there is a match to any one of the plurality of reference hash values, wherein the plurality of reference hash values were generated by applying the hash algorithm to each component part of a plurality of reference binary images.

63. The computer of claim 62, further means for comprising providing an output identifying a number of component hash values which match one or more reference hash values.

64. The computer of claim 63, further comprising means for outputting a percentage of component parts that match component parts within a reference function.

65. The computer of claim 57, further comprising means for providing an output comparing an order of matched component parts within a selected function to an order of matched component parts within a reference function.

66. A tangible storage medium having stored thereon processor-executable software instructions configured to cause a processor of a computer to perform steps comprising:
normalizing memory registers and memory address references within a software binary image to generate a normalized binary image;
identifying functions within the normalized binary image; and
comparing each identified function in the normalized binary image to a reference binary image to determine if there is a match.

67. The tangible storage medium of claim 66, wherein the tangible storage medium has stored thereon processor-executable software instructions configured to cause a processor of a computer to perform steps such that the step of comparing comprises comparing each identified function in the normalized binary image to each of a plurality of reference binary images to determine if there is a match to any one of the plurality of reference binary images.

68. The tangible storage medium of claim 66, wherein the tangible storage medium has stored thereon processor-executable software instructions configured to cause a processor of a computer to perform steps such that the step of comparing comprises:
selecting one of the identified functions within the normalized binary image; and
comparing the selected one of the identified functions to the reference binary image by comparing a bit pattern in the selected one of the identified functions to a bit pattern in the reference binary image to determine if there is a match.

69. The tangible storage medium of claim 66, wherein the tangible storage medium has stored thereon processor-executable software instructions configured to cause a processor of a computer to perform steps further comprising:
selecting a next one of the identified function within the normalized binary image; and
comparing the selected next one of the identified functions to the reference binary image by comparing a bit pattern in the selected next one of the identified functions to a bit pattern in the reference binary image to determine if there is a match.

70. The tangible storage medium of claim 66, wherein the tangible storage medium has stored thereon processor-executable software instructions configured to cause a processor of a computer to perform steps such that the step of comparing comprises:
selecting one of the identified functions within the normalized binary image;
applying a hash algorithm to the selected one of the identified functions to generate a first hash value; and
comparing the first hash value to a first reference hash value to determine if there is a match, wherein the first reference hash value was generated by applying the hash algorithm to the reference binary image.

71. The tangible storage medium of claim 70, wherein the tangible storage medium has stored thereon processor-executable software instructions configured to cause a processor of a computer to perform steps further comprising:
selecting a next one of the identified functions within the normalized binary image;
applying the hash algorithm to the selected next one of the identified functions to generate a second hash value; and
comparing the second hash value to the first reference hash value to determine if there is a match.

72. The tangible storage medium of claim 70, wherein the tangible storage medium has stored thereon processor-executable software instructions configured to cause a processor of a computer to perform steps such that the step of comparing the first hash value to a reference hash value comprises comparing the first hash value to each of a plurality of reference hash values to determine if there is a match to any one of the plurality of reference hash values, wherein the plurality of hash values were generated by applying the hash algorithm to each of a plurality of reference binary images.

73. The tangible storage medium of claim 66, wherein the tangible storage medium has stored thereon processor-executable software instructions configured to cause a processor of a computer to perform steps further comprising:
identifying component parts within at least one of the identified functions;
selecting a first one of the identified component parts;
applying a hash algorithm to the selected first one of the identified component parts to generate a component hash value; and
comparing the component hash value to a reference hash value to determine if there is a match, wherein the reference component hash value was generated by applying the hash algorithm to a component part of the reference binary image.

74. The tangible storage medium of claim 70, wherein the tangible storage medium has stored thereon processor-executable software instructions configured to cause a processor of a computer to perform steps further comprising:
identifying component parts within at least one of the identified functions;
selecting a first one of the identified component parts;
applying the hash algorithm to the selected first one of the identified component parts to generate a component hash value; and
comparing the component hash value to a second reference hash value to determine if there is a match, wherein the reference component hash value was generated by applying the hash algorithm to a component part of the reference binary image.

75. The tangible storage medium of claim 66, wherein the tangible storage medium has stored thereon processor-executable software instructions configured to cause a processor of a computer to perform steps further comprising normalizing branching addresses within the normalized binary image.

76. A tangible storage medium having stored thereon processor-executable software instructions configured to cause a processor of a computer to perform steps comprising:
a processor; and
a memory coupled to the processor,
wherein the processor is configured with software instructions to perform steps comprising:
normalizing memory registers and memory address references within the software binary image to generate a normalized binary image;
identifying functions within the normalized binary image;
identifying component parts within each of the identified functions;
selecting one of the identified functions within the normalized binary image;
selecting one of the identified component parts within the selected one of the identified functions;
applying the hash algorithm to the selected one of the identified component parts to generate a component hash value; and
comparing the component hash value to a reference hash value to determine if there is a match, wherein the reference hash value was generated by applying the hash algorithm to a component part of a reference function binary image.

77. The tangible storage medium of claim 76, wherein the tangible storage medium has stored thereon processor-executable software instructions configured to cause a processor of a computer to perform steps such that the step of comparing the component hash value to a reference hash value comprises comparing the component hash value to each of a plurality of reference hash values to determine if there is a match to any one of the plurality of reference hash values, wherein the plurality of reference hash values were generated by applying the hash algorithm to each component part of a plurality of reference binary images.

78. The tangible storage medium of claim 76, wherein the tangible storage medium stored thereon processor-executable software instructions configured to cause a processor of a computer to perform steps further comprising normalizing branching addresses within the normalized binary image.

79. The tangible storage medium of claim 76, wherein the tangible storage medium stored thereon processor-executable software instructions configured to cause a processor of a computer to perform steps such that the steps of selecting one of the identified component parts within the selected one of the identified functions, applying the hash algorithm to the selected one of the identified component parts to generate a component hash value, and comparing the component hash value to a reference hash value are repeated until each component hash value for each one of the component parts of the selected one of the identified functions has been compared to the reference hash value.

80. The tangible storage medium of claim 79, wherein the tangible storage medium stored thereon processor-executable software instructions configured to cause a processor of a computer to perform steps such that the step of selecting one of the identified functions within the normalized binary image is repeated until all component hash values for each one of the component parts of each one of the identified functions within the normalized binary image has been compared to the reference hash value.

81. The tangible storage medium of claim 80, wherein the tangible storage medium stored thereon processor-executable software instructions configured to cause a processor of a computer to perform steps such that the step of comparing the component hash value to a reference hash value comprises comparing the component hash value to each a plurality of reference hash values to determine if there is a match to any one of the plurality of reference hash values, wherein the plurality of reference hash values were generated by applying the hash algorithm to each component part of a plurality of reference binary images to determine if there is a match.

82. The tangible storage medium of claim 81, wherein the tangible storage medium stored thereon processor-executable software instructions configured to cause a processor of a computer to perform steps further comprising providing an output identifying a number of component hash values which match one or more reference hash values.

83. The tangible storage medium of claim 82, wherein the tangible storage medium stored thereon processor-executable software instructions configured to cause a processor of a computer to perform steps such that the output is a percentage of component parts that match component parts within a reference function.

84. The tangible storage medium of claim 76, wherein the tangible storage medium stored thereon processor-executable software instructions configured to cause a processor of a computer to perform steps further comprising providing an output comparing an order of matched component parts within a selected function to an order of matched component parts within a reference function.
